(19) United States
(12) Patent Application Publication
(10) Pub. No.: US 2025/0335921 A1
(43) Pub. Date: Oct. 30, 2025

(54) METHODS AND SYSTEMS FOR VERIFYING ANTI-TAMPERING OF DATA

(71) Applicant: Fin3 Technologies, Inc., New York, NY (US)

(72) Inventors: Albert SZMIGIELSKI, Surrey BC (CA); Adam YARNOLD, New York, NY (US)

(21) Appl. No.: 19/187,780

(22) Filed: Apr. 23, 2025

Related U.S. Application Data
(60) Provisional application No. 63/638,182, filed on Apr. 24, 2024.

(51) Int. Cl. G06Q 20/40; G06Q 20/38

(52) U.S. Cl. CPC G06Q 20/407; G06Q 20/3829; G06Q 20/4014

(57) ABSTRACT

Described herein are methods and systems for validating financial network traffic to authenticate payment instruments. Such systems and methods may comprise generating, at least in part by a verification engine comprising a hash function, payment instrument verification system (PIVS) data, wherein the hash function outputs a unique string of characters for a payment instrument associated with a payor; detecting, from payment instrument data received from a payee, a subset of information associated with a payment instrument associated with the payee; processing the data received from the payee using at least a PIVS database comprising the PIVS data to determine authenticity of the payment instrument associated with the payee; and blocking a transfer of funds from the payor to the payee upon determining a lack of authenticity of the payment instrument associated with the payee.

### CROSS-REFERENCE TO RELATED APPLICATIONS

This application claims priority to U.S. Provisional Application No. 63/638,182, filed Apr. 24, 2024, which is incorporated by reference herein in its entirety.

### BACKGROUND

Payment transactions may be performed in a variety of ways. For example, a payor may provide different types of payment instruments to initiate the transaction. The types of payment instruments may include a physical check, an electronic check, an electronic money transfer, and others. The payee or the processor who processes the payment instrument must verify that the payment instrument received is valid. This process may not be instantaneous and take some time. For example, when the payee wants to cash a check, validating the check may include several steps such as checking the payor's identification to make sure the payor's information such as name and address matches the information on the check, verifying via a verification service whether the payor's routing number and account number are active, and/or examining the ink or print of the writing on the check. However, these steps may not be sufficient to validate the authenticity of the check, and the payee may end up with a check that is not valid. Similar problems may arise for other types of payment instruments as well.

### SUMMARY

Methods and systems are provided herein for verifying authenticity of a payment instrument.

One aspect includes a method of verifying authenticity of a payment instrument, comprising: (a) generating payment instrument verification system (PIVS) data comprising a unique string of characters associated with the payment instrument; (b) receiving, from a payee of the payment instrument, the PIVS data and payment instrument data, wherein the payment instrument data comprises a subset of information associated with the payment instrument; (c) processing the PIVS data and the payment instrument data using at least a PIVS database to determine authenticity of the payment instrument; and (d) providing an indicator of the authenticity of the payment instrument to the payee.

In some embodiments, in (a), the PIVS data is generated based at least in part on the payment instrument data.

In some embodiments, in (a), generating the PIVS data comprises providing at least some of the payment instrument data to a hash function to generate a hash output.

In some embodiments, the method further comprises generating the PIVS data based at least in part on the hash output and a payor's private key.

In some embodiments, the unique string of characters is unique to the payor's private key and the information associated with the payment instrument.

In some embodiments, the unique string of characters is unique to the information associated with the payment instrument.

In some embodiments, the unique string of characters comprises hexadecimal characters.

In some embodiments, the unique string of characters comprises at least 30 characters.

In some embodiments, the unique string of characters comprises letters, numbers, and/or symbols.

In some embodiments, the payment instrument comprises a check, and wherein payment instrument data comprises one or more of payor's information, payee's information, date, amount, account information, check number, or a check memorandum section.

In some embodiments, the method further comprises, prior to (a), generating the image of the check based at least in part on the payment instrument data received from a payor.

In some embodiments, the image comprises a scanned copy of a physical check comprising the check, wherein the physical check is handwritten or printed.

In some embodiments, the method further comprises, after generating the image, electronically augmenting or superimposing the PIVS data over the image of the check.

In some embodiments, the image comprises a digitally generated image without a physical check or a scanned copy thereof.

In some embodiments, the digitally generated image comprises the PIVS data on the image.

In some embodiments, the PIVS data does not overlap the payment instrument data on the check.

In some embodiments, the method further comprises transmitting the image of the check to the payee.

In some embodiments, the image comprises a QR code that reveals the PIVS data when scanned.

In some embodiments, the payor's information includes the payor's name and/or address.

In some embodiments, the payee's information includes the payee's name.

In some embodiments, the date includes the date of when the check was created.

In some embodiments, the account information includes a routing number and an account number of the payor.

In some embodiments, the method further comprises, after (d), when the check is determined to be invalid or potentially invalid, receiving an image of the check to validate the check using additional information.

In some embodiments, the method further comprises, after receiving the image of the check, extracting additional payment instrument data from the image of the check.

In some embodiments, the method further comprises, after extracting the additional payment instrument data, providing the additional payment instrument data to the PIVS database to re-assess the authenticity of the check.

In some embodiments, the payment instrument comprises a digital negotiable instrument (DNI), and wherein payment instrument data comprises one or more of a version of a DNI data structure, a version of a DNI record, an identification of the payee using a public key associated with the payee, an identification of the payor using a public key associated with the payor, an amount of the DNI, a creation day or time, an update day or time, a digital signature of the payor, a digital signature of the payee, a number of permissible transactions, a duration of time to negotiate or settle the DNI, a negotiable indicator, a funds guarantee indicator, an identification of a financial entity, a status of the DNI, optional data associated with processing of the DNI, or one or more types of metadata associated with the financial obligation.

In some embodiments, the payment instrument comprises a digital draft, and wherein payment instrument data comprises one or more of a version of a digital draft data structure, a version of a digital draft record, an identification of the payee using a public key associated with the payee, an identification of the payor using a public key associated with the payor, an amount of the digital draft, a creation day or time, a digital signature of the payor, a digital signature of the payee, a number of permissible transactions, a duration of time to negotiate or settle the digital draft, a negotiable indicator, a funds guarantee indicator, an identification of a financial entity, a status of the digital draft, optional data associated with processing of the digital draft, or one or more types of metadata associated with the financial obligation.

In some embodiments, the PIVS database comprises a table or array that links the PIVS data to the associated payment instrument data.

In some embodiments, the method further comprises, prior to (a), generating an entry in the table or array, wherein the entry comprises the PIVS data and the information associated with the payment instrument.

In some embodiments, in (c), processing the PIVS data and the payment instrument data comprises: (i) comparing the received PIVS data and payment instrument data against the PIVS data and payment instrument data in the entry of the PIVS database; and (ii) outputting an invalid indicator if the received PIVS data does not match the PIVS data in the entry and a valid indicator if the received PIVS data matches the PIVS data in the entry.

Another aspect includes non-transitory computer-readable media comprising executable instructions that, when executed, cause at least one computer processor to perform the method described herein.

Another aspect includes a computer system comprising a memory storing computer-readable instructions and at least one processor configured to execute the computer-readable instructions that are configured to perform the method described herein.

Additional aspects and advantages of the present disclosure will become readily apparent from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature and not as restrictive

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a non-limiting example of a payment instrument verification system (PIVS), in accordance with some embodiments;

FIG. 2 illustrates a non-limiting exemplary block diagram of a process for verifying the authenticity of a payment instrument, in accordance with some embodiments; and

FIG. 3 illustrates a non-limiting example of a computer system that is programmed or otherwise configured to perform methods and systems described herein, in accordance with some embodiments.

### DETAILED DESCRIPTION

While various embodiments of the disclosure have been shown and described herein, such embodiments are provided by way of example only. Numerous variations, changes, or substitutions may occur without departing from the disclosure. It should be understood that various alternatives to the embodiments of the disclosure described herein may be employed.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics can be combined in any suitable manner in one or more embodiments.

As used herein, the term “real-time” generally refers to a response time of less than 10 minutes, 1 minutes, 1 second, tenth of a second, hundredth of a second, a millisecond, or less, such as by a computer processor. Real-time can also refer to a simultaneous or substantially simultaneous occurrence of a first event with respect to occurrence of a second event. Substantially as used in the above context may refer to a deviation of between +1% to +10% of an expected response time, execution time or execution speed.

### Overview

Check fraud continues to be a major problem, as fraudulent checks are becoming more sophisticated and virtually indistinguishable from authentic checks. This is one of the reasons a check can take multiple days to process and settle by the payor's bank. Even if a bank teller “clears” a check by providing cash to the person who brought the check, the bank is taking a risk because there is no certainty that the check was authentic. It could take days or weeks before the bank realizes that the payor in fact did not issue the check to the person who brought the check.

For example, when a physical check is issued by the payor, the payee still has to cash the check whether by mobile phone (using the phone's camera, for example) or at a branch of a financial institution, like the payee's bank. The bank employee (e.g., a bank teller) has to verify whether the received check is authentic or not in order to transfer funds from the payor's account to the payee's account, or provide cash to the payee from the payor's account. A typical process of verification may include multiple steps. For example, a bank may try to verify whether the name on the check spelled correctly and matches the name on the account number in the check, whether the routing number and account number on the check match the information about the payor, whether the paper on which the check is printed is genuine (e.g., printed/provided by the bank), whether the signature on the signature line is authentic (e.g., matching the payor's signature with previous signatures, etc.), and/or whether the address on the check matches the payor's information in the bank's database.

Although the above example is provided with respect to a check, the present disclosure is not limited thereto. Any payment instrument that requires authentication is susceptible to fraud by bad actors. Accordingly, there is a need to reliably and quickly verify the authenticity of a payment instrument.

Further to the advantages conferred in the reduction of fraudulent financial activity, the systems and methods herein confer several technical advantages over existing technologies. In one example, the systems and methods herein may implement hash functions for authentication of payment instruments. Hashing provides particular advantage by ensuring unique representations of data in a database. This provides a secure way to authenticate inputs for a reference hash. For example, a payment instrument may be associated with a reference hash of the payment instrument that is effectively impossible for a potential fraudster to replicate without exact details of the reference, or true, payment instrument. Yet further, hashing provides a database search with near constant time complexity, indicating database searches that are independent of number of entries. Put another way, search of a database with one entry is effectively the same as search of a database with a trillion entries. Accordingly, the unique hashing approach described herein provides both security and computational efficiency.

In addition to the advantages described above, the systems and methods herein may reduce network traffic by blocking fraudulent transactions and, in some cases, comprise human-in-the-loop verification. For example, images of a financial instrument may be used for payee authentication. This may provide advantage by mitigating risk of automated attempts at financial fraud while further promoting efficient computational networks with reduced exposure to malicious attacks.

Recognized herein is a need for methods or systems for verifying the authenticity of a payment instrument. In this disclosure, a payment instrument may include one or more types of payments that are issued or initiated by the payor that can be received by the payee for receipt of payment. For example, a payment instrument may include a digital or electronic check, a physical check, a digital negotiable instrument, a digital draft, automated clearing house (ACH) transfer, and any other form of physical or electronic payment. The transfer of funds from the payor's account to the payee's account may not be instantaneous and there may be one or more steps of verifying whether the payment instrument is valid.

### System for Verifying Authenticity of a Payment Instrument

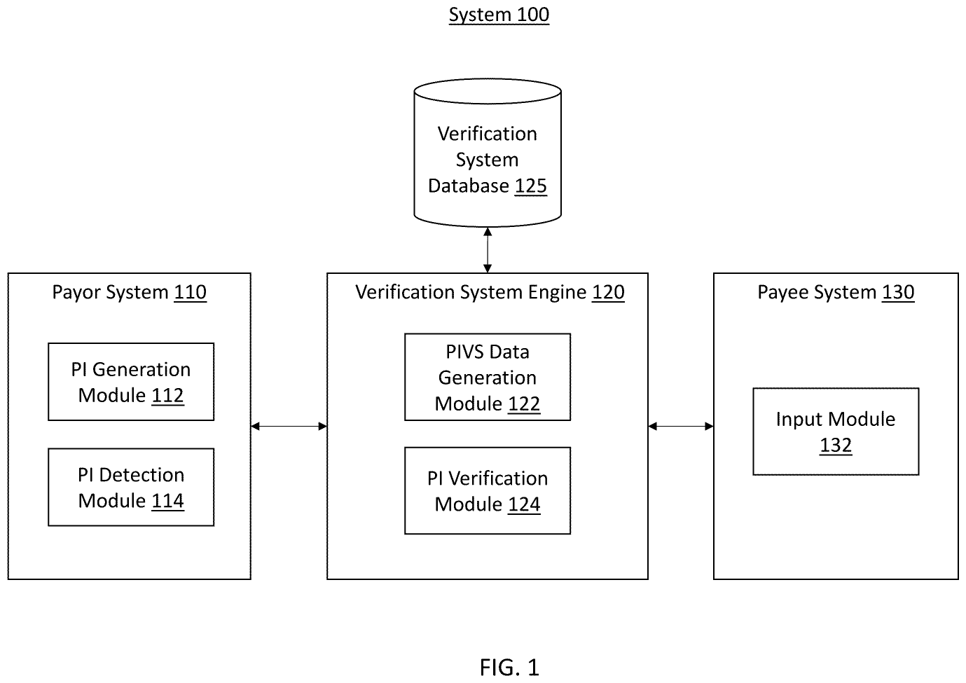

Referring to FIG. 1, an example system 100 for verifying authenticity of a payment instrument is shown, in accordance with some embodiments. The system 100 may include a payor system 110, a verification system engine 120, a verification system database 125, and a payee system 130. Although certain components are shown, embodiments are not limited thereto, and there may be more or fewer components within the system 100, such as payment processors, network nodes, financial institutions on payor and/or payee side, etc. For example, the payee system 130 may include a financial institution that is configured to perform one or more of the functions below.

In some embodiments, the payor system 110 may include a system that the payor is using to initiate the transaction. For example, the payor system 110 may include a bank system in which the payor's account is hosted such as a checking account. The payor can, using an electronic device such as a computer, tablet, smartphone, or any electronic device, initiate the payment to a payee. In some embodiments, the payor can also write a check (that was printed by the payor's bank) to the payee who can then cash the check to deposit into the payee's account in the payee system 130, and the payor system 110 may withdraw funds from the payor's account and the payee system 130 may deposit the funds into the payee's account. In some embodiments, the payor can issue a physical check to be sent via the payor system 110's online portal. In some embodiments, the payor can initiate a transfer to the payee using DNI, digital drafts, ACH transfers, or any other form of physical or electronic payment. In this disclosure, although the term “bank” is used for convenience, this can include any traditional bank, online bank, credit union, etc.

In some embodiments, the payor system 110 may comprise a software application or a sub-application that is connected to the bank or financial institution where the payor's account hosted via a set of application programming interface (API). The application may be connected to the verification system engine 120 and be able to transmit and receive information from the verification system engine 120. In some embodiments, the sub-application may be hosted on the financial institution's website or application and connected to the verification system engine 120 via APIs. In some embodiments, the payor system 110 may include a standalone application that is connected to the payor's account hosted by the financial institution.

In some embodiments, the payor system 110 may include a payment instrument (PI) generation module 112 and a payment instrument detection module 114. In some embodiments, the PI generation module 112 may be used to generate and/or initiate generation of the payment instrument such as a check, digital draft, DNI, etc. In some embodiments, the PI generation module 112 may generate the PIVS data based on the PI information and the payor's private key. Then the PI information and the PIVS data may be provided to the verification system database 125 to create a new entry in the table or array. In some embodiments, the PI information may be transmitted to the verification system engine 120, and the PIVS data generation module 122 may generate the PIVS data using the payor's private key. Then the PIVS data and the PI information may be transmitted to the verification system database 125 to be saved.

In some embodiments, the payment instrument detection module 114 may be used to detect or scan a payment instrument. In some embodiments, the payor may write and sign a physical check which is not generated by the PI generation module 112. In this situation, the payor may use an electronic device such as a smartphone to take a photo of the check which may be scanned. In some embodiments, the PI information may be transmitted to the verification system engine 120 so that the PIVS data may be generated by the PIVS data generation module 122. Then the PIVS data and the PI information may be transmitted to the verification system database 125 to be saved. Although checks are described with respect to detection, embodiments are not limited thereto and other forms of physical payment instruments may be used such as a money order.

In some embodiments, the payee system 130 may include a system that the payee is using to receive payment from the payor. For example, the payee system 130 may include a banking system that is hosting the payee's account, such as a checking account. The payee may be able to deposit the funds that the payor paid into the payee's account on the payee system 130. In some embodiments, the payee may cash a check at the teller of the payee system or take a photo of the check using an electronic device. In some embodiments, the payee may not use the payee system 130 and instead cash the check without depositing the funds into the payee's account hosted on the payee system 130. In this disclosure, the terms “payee system” and “payee” are used interchangeably, depending on whether the payee is cashing the payment instrument (“payee”) or receiving the payment instrument via an electronic payment (“payee system”). In some embodiments, the payee may use the payee system to cash the payment instrument. In some embodiments, the payee system 130 may include an electronic device that the payee is using, such as a smart phone, tablet, or computer.

In some embodiments, the payee system 130 may include an input module 132. The input module 132 may receive one or more inputs from the payee such as the PIVS data from the payment instrument and the payment instrument data from the payment instrument.

In some embodiments, the payor system 110 and the payee system 130 may be part of the same system. For example, the payor system 110 and the payee system 130 may be part of the same bank. In some embodiments, the payor system 110 and the payee system 130 may be part of different systems. For example, the payor system 110 may be part of a first bank, and the payee system 130 may be part of a second bank. Furthermore, in some embodiments, the payor system 110, the payee system 130, and the verification system engine 120 may all be part of the same system.

In some embodiments, the payee system 130 may comprise a software application or a sub-application that is connected to the bank or financial institution where the payee's account hosted via a set of application programming interface (API). The application may be connected to the verification system engine 120 and be able to transmit and receive information from the verification system engine 120. In some embodiments, the sub-application may be hosted on the financial institution's website or application and connected to the verification system engine 120 via APIs. In some embodiments, the payee system 130 may include a standalone application that is connected to the payee's account hosted by the financial institution.

In some embodiments, the verification system engine 120 may include a payment instrument verification system (PIVS) data generation module 122 and a PI verification module 124. In some embodiments, the verification system engine 120 can perform at least some or all of the functions of the payment instrument verification process. Although a certain number of modules are shown to be included in the verification system engine 120, embodiments are not limited thereto, and more or fewer modules may be included.

In some embodiments, the PIVS data generation module 122 may generate the PIVS data based at least in part on the payment instrument data and a payor's private key. In some embodiments, the PIVS data may be unique to the set of payment instrument data that is used to generate the PIVS data. In some embodiments, generating the PIVS data comprises providing at least some of the payment instrument data to the PI generation module. In some embodiments, all of the available payment instrument data may be used to generate the PIVS data.

In some embodiments, generating the PIVS data comprises providing at least some of the payment instrument data to a hash function to generate a hash output. In some embodiments, the payment instrument data may be provided by a payor, payee, or both. In some embodiments, the hash function may receive as input a subset of the payment instrument data. In some embodiments, the hash function may receive as inputs all of the payment instrument data. In some embodiments, the PIVS data may be generated based at least in part on the hash output and the payor's private key. For example, the hash output may be signed by the payor's private key to generate a string of characters that is unique to the payor that can be used as PIVS data. The payor's private key may be generated by the verification system engine 120 such that the private key is unique to the payor. Accordingly, the PIVS data, which is generated based on a hash function of information of the payment instrument and the payor's private key, the PIVS data may be unique.

In some embodiments, the PI verification module 124 may be used to verify whether the payment instrument corresponding to the generated PIVS data is authentic. For example, the PI verification module 124 may receive as inputs the PIVS data provided by the payee and any piece of information on the payment instrument and output whether the payee's input (e.g., the PIVS data and the at least one piece of information) accurately matches or not by checking whether the at least one piece of information was used to generate the PIVS data. If so, the PI verification module 124 may provide an output that indicates the payee's input is verified, and PI verification module 124 may authorize the transfer of funds from the payor to the payee. If the inputs does not match each other, the PI verification module 124 may prompt the payee to enter additional information about the payment instrument (e.g., date or payee name) as additional steps of the verification process. If the input is still not verified after the additional steps, the payee may be instructed to upload an image of the payment instrument (e.g., image of the check taken using the payee's electronic device). The PI verification module 124 may then try to determine whether the PI is authentic or not by matching PIVS data to at least one piece of information on the payment instrument. If there is a match, the transfer may be authorized and completed. If not, the payee may be notified that the information cannot be verified and to contact the payor to re-issue the payment instrument.

In some embodiments, the verification system database (or PIVS database) 125 may communicate with the verification system engine 120. In some embodiments, at least some or all of the information of the payment instrument may be saved to the verification system database 125 when the payment instrument is first generated or written. For example, when an electronic check is first generated by the payor system 110, the information on the payment instrument such as payor name, address, payment amount, date, routing number, account number, check number, electronic signature, and/or other information on the check may be provided to the verification system database 125 and saved.

In some embodiments, the PIVS database comprises a table or array that links the PIVS data to the associated payment instrument data. In some embodiments, an entry or record in the table or array may be generated, wherein the entry comprises the PIVS data and the information associated with the payment instrument. An entry may be created for every payment instrument that is generated by the PI generation module 112 or detected by the PI detection module 114.

In some embodiments, a hash function as described herein may be used to map data of arbitrary size to a fixed-size value. In some cases, a hash function may comprise a cryptographic hash function. Generally, a hash function may take as input at least a portion of data of a payment instrument and output a hash code for storage in a hash table. In some cases, the hash table may be stored in the verification system database 125. In some cases, a hash function may comprise or function similarly to the Secure Hash Algorithms (SHA) family of algorithms, MD5, BLAKE2, BLAKE3, Murmur, RIPEMD, or Whirlpool.

### Method of Verifying of Authenticity of Payment Instrument

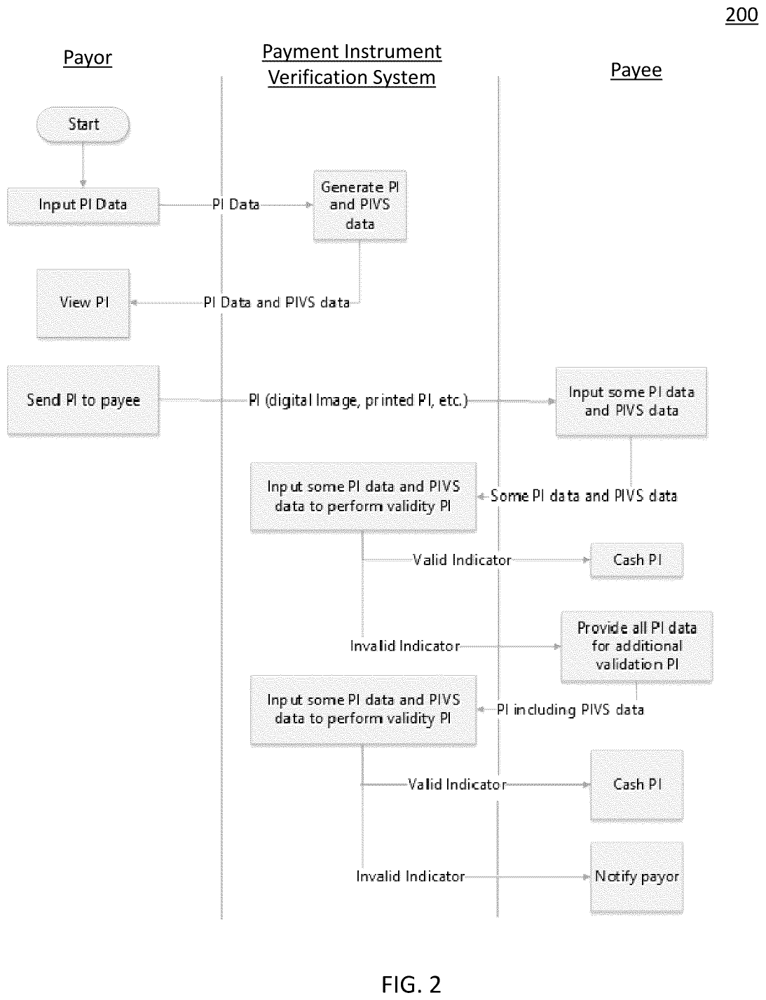

FIG. 2 illustrates a non-limiting exemplary block diagram of a process 200 for verifying the authenticity of a payment instrument, in accordance with some embodiments. Although certain steps are shown to be performed in process 200, embodiments are not limited thereto, and more or fewer steps may be performed. Further, although FIG. 2 shows the payee performing certain steps of process 200, some or all of these steps may be performed by the financial institution that is cashing the payment instrument on behalf of the payee. For example, the bank that is hosting the payee's account may perform the steps for verifying the payment instrument and cashing the payment instrument.

In some embodiments, a method of verifying authenticity of a payment instrument is disclosed. In some embodiments, the method comprises: (a) generating payment instrument verification system (PIVS) data comprising a unique string of characters associated with the payment instrument; (b) receiving, from a payee of the payment instrument, the PIVS data and payment instrument data, wherein the payment instrument data comprises a subset of information associated with the payment instrument; (c) processing the PIVS data and the payment instrument data using at least a PIVS database to determine authenticity of the payment instrument; and (d) providing an indicator of the authenticity of the payment instrument to the payee.

In some embodiments, the method may comprise generating payment instrument verification system (PIVS) data comprising a unique string of characters associated with the payment instrument. As discussed elsewhere herein, the PIVS data may be generated by a PIVS data generation module in the verification system engine 120. In some embodiments, PI generation module in the payor system may generate the PIVS data. In some embodiments, the PIVS data may include a unique string of characters. In some embodiments, the unique string of characters is unique to the payor's private key and the information associated with the payment instrument (e.g., payment instrument data). In some embodiments, the unique string of characters is unique to the information associated with the payment instrument. In some embodiments, the unique string of characters comprises hexadecimal characters. In some embodiments, the unique string of characters comprises at least 30 characters, but embodiments are not limited thereto, and the unique string of characters may be 20 characters, 25 characters, 35 characters, 40 characters, or more. In some embodiments, the unique string of characters comprises letters, numbers, and/or symbols.

In some embodiments, the method may comprise receiving, from a payee of the payment instrument, the PIVS data and payment instrument data, wherein the payment instrument data comprises a subset of information associated with the payment instrument. In some embodiments, the payee may provide the PIVS data and payment instrument data using the input module 132 in the payee system 130. In some embodiments, the payee may be prompted more than once to provide the payment instrument data, for example if the initially provided set of payment instrument data does not match the entry corresponding to the provided PIVS data.

In some embodiments, the payment instrument may be verified by ensuring that the information received by the payee matches the information in the verification system database 125. In some embodiments, the method may include processing the PIVS data and the payment instrument data which may comprise: (i) comparing the received PIVS data and payment instrument data against the PIVS data and/or payment instrument data in the entry of the PIVS database; and (ii) outputting an invalid indicator if the received PIVS data and/or the payment instrument data do not match the PIVS data and/or the payment instrument data in the entry and a valid indicator if the received PIVS data and/or the payment instrument data match the PIVS data and/or the payment instrument data in the entry. In some embodiments, the payment information data may include a subset of the information related to the payment instrument (e.g., payment amount only, or payment amount and date only, or other combination of sets of information) or all of the information related to the payment instrument.

In some embodiments, the verification system engine 120 may retrieve data corresponding to the entry in the verification system database 125 based on the PIVS data that is provided by the payee or the cashing institution. The retrieved record may include all of the information related to the entry or a subset of the information (e.g., the type of information that was provided by the payee along with the PIVS data). For example, if the payee provided the PIVS data from the payment instrument, the amount, and the date, the verification system engine 120 may retrieve the amount and date in the entry associated with the PIVS data. In some embodiments, the verification system engine 120 may retrieve the entire entry and save the entire entry locally in case the initial verification step fails. For example, if matching the payment amount fails, the process may move to verifying other information such as date or payee info.

In some embodiments, when the payment instrument includes a check, the payment instrument data may include one or more pieces of information from the payment instrument, such as payor's information, payee's information, date, amount, account information, check number, or a check memorandum section. The payment instrument data of a digital draft may be similar to or the same as a check.

In some embodiments, when the payment instrument comprises a DNI, and payment instrument data may include one or more of a version of a DNI data structure, a version of a DNI record, an identification of the payee using a public key associated with the payee, an identification of the payor using a public key associated with the payor, an amount of the DNI, a creation day or time, an update day or time, a digital signature of the payor, a digital signature of the payee, a number of permissible transactions, a duration of time to negotiate or settle the DNI, a negotiable indicator, a funds guarantee indicator, an identification of a financial entity, a status of the DNI, optional data associated with processing of the DNI, or one or more types of metadata associated with the financial obligation.

In some embodiments, a payor may be notified in real-time of a failed payee authentication. In some cases, a mobile device of the payor may receive a notification of a failed payee authentication. For example, a failed authentication of a payee (or a payment instrument thereof) may cause a graphical user interface (GUI) to display a notification that a payee is attempting to execute a transaction with a payment instrument allegedly associated with the payor. This may provide particular advantage by mitigating fraud in financial transactions by ensuring all payors associated with a network are timely notified by fraudulent attempts at transferring funds from payor accounts. In some cases, this may facilitate secure financial transactions by initiating contact between a payor and a payee to settle an intended transaction.

### Verification of Authenticity of a Check

In some embodiments, the method may comprise processing the PIVS data and the payment instrument data using at least a PIVS database to determine authenticity of the payment instrument. An example is described with respect to a check, but embodiments are not limited thereto, and other forms of payment instruments are contemplated herein.

In some embodiments, the payment instrument comprises a check, wherein payment instrument data comprises one or more of payor's information, payee's information, date, amount, account information, check number, or a check memorandum section. In some embodiments, the payor's information may include payor's name, payor's address, and/or payor's phone number. In some embodiments, the payee's information may include payee's name and/or contact information such as email, phone number, and/or address. In some embodiments, the date may include the date that the payor issued the payment instrument or the date that the payment instrument is set to expire. In some embodiments, the amount may include the amount of money that the payor is trying to convey to the payee. The amount may be in any fiat currency, digital currency, or any other form of currency. In some embodiments, the account information may include the routing number and/or account number of the payor and/or the payee. In some embodiments, the check memorandum section may include any string of characters that the payor has written as a note to the payee or the financial institution that is cashing the check.

In some embodiments, the method further comprises, prior to generating the PIVS data, generating the image of the check based at least in part on the payment instrument data received from a payor. In some embodiments, the image comprises a scanned copy of a physical check (e.g., via the PI detection module 114) comprising the check, wherein the physical check is handwritten or printed. In some embodiments, the method further comprises, after receiving the image of the check, extracting additional payment instrument data from the image of the check.

In some embodiments, the method further comprises, after generating the image, electronically augmenting or superimposing the PIVS data over the image of the check. In some embodiments, after the payment instrument data is recognized (e.g., via optical character recognition, etc.), the PIVS data can be generated using the methods described herein. Then, in some embodiments, the PIVS data can be added to the image of the check so that the PIVS data is visible for the payee or anyone else to read. In some embodiments, the PIVS data does not overlap the payment instrument data on the check.

In some embodiments, the image comprises a digitally generated image without a physical check or a scanned copy thereof. For example, when the payor issues an electronic check using the payor system, a physical check may not be created. Instead, a check may be generated with an image of a check. In some embodiments, the digitally generated image comprises the PIVS data on the image.

In some embodiments, the method further comprises transmitting the image of the check to the payee. The image of the check may include the PIVS data. In some embodiments, the image may be transmitted by any known method of electronic communication such as email, texting, messenger, or via a communications module (not shown) of the verification system engine.

In some embodiments, the image comprises a QR code that reveals the PIVS data when scanned. Instead of the PIVS data including the string of characters being added to the image, a QR may be added that the payee can scan using a mobile device. Scanning the QR code can reveal the PIVS data, which can then be added to the input module. In some embodiments, scanning the QR code automatically inputs the PIVS data into the input module. Furthermore, the payee system may include a scanning module that can scan or read the entire image of the check and automatically input the payment instrument data and PIVS data from the check to the input module. Then the payee system can submit the PIVS data and the payment instrument data for verification.

In some embodiments, the method comprises providing an indicator of the authenticity of the payment instrument to the payee. In some embodiments, the PI verification module may provide an output or an indicator of valid or invalid. A valid output or indicator means that the payment instrument data provided by the payee matches what is stored in the verification system database for the entry containing the provided PIVS data. An invalid output or indicator means that the payment instrument data provided by the payee does not match what is stored in the verification system database for the entry containing the provided PIVS data. If the PIVS data that was provided by the payee is not in the verification system database, the PI verification module can provide an output indicating that the provided PIVS data does not exist and prompt the payee to provide a valid PIVS data.

In some embodiments, if the output is invalid, the payee may be prompted to provide the payment instrument data again or to provide additional payment instrument data that was not provided previously. For example, if the provided amount does not match, the payee may be prompted to enter the amount again. Then the PI verification module will determine whether the newly provided amount matches the amount in the database. As another example, if the previous payment instrument data that was provided by the payee was the amount, the payee may provide the date or other payment instrument data. Then the PI verification module may determine whether the newly provided payment instrument data matches the corresponding information in the database.

In some embodiments, the method further comprises, when the check is determined to be invalid or potentially invalid, receiving an image of the check to validate the check using additional information. Since the payee may be inputting the wrong information from the check, the payee may be asked to provide an image of the check. The payee system may convert the image into a readable format such that the payment instrument data can be obtained from the image. In some embodiments, the method further comprises, after extracting the additional payment instrument data, providing the additional payment instrument data to the PIVS database to re-assess the authenticity of the check.

In some embodiments, an invalid output may be an indication that the payment instrument may have been tampered with, as the information on the payment instrument as provided by the payee does not match the information on the payment instrument at the time of issuing the payment instrument by the payor. After the invalid output is generated, the payor may be notified that someone had unsuccessfully tried to cash the check that the payor had issued.

Another aspect of the disclosed technology includes non-transitory computer-readable media comprising executable instructions that, when executed, cause at least one computer processor to perform the method described herein. Another aspect includes a computer system comprising a memory storing computer-readable instructions and at least one processor configured to execute the computer-readable instructions that are configured to perform the method described herein.

### Digital Negotiable Instrument and Controllable Electronic Records

A controllable electronic record (CER) can include a record stored in an electronic medium that can be subjected to control. In some cases, the CER is a type of intangible digital asset. Control or ownership of the CER can establish acquisition and disposition of rights or interests in digital assets such as digital negotiable instrument (DNI) or digital draft. Methods and systems described herein can provide technical advantages for determining control or ownership of a CER. Advantages can include greater certainty in digital asset transactions. For example, advantages can include greater certainty for qualifying entities (e.g., qualifying purchasers) by ensuring that they acquire CERs free from any prior security interest. Advantages can include real-time sharing of information in a standardized format. For example, advantages can include allowing remote entities (e.g., a payor and a payee) to share information in real time in a standardized structure of a CER. Information can relate to, for example, transactions transferring control or ownership of the CER from one entity to another entity. Advantages can include automatically generating or transmitting messages. For example, advantages can include automatically generating messages when transactions occur on a CER and transmitting messages to all entities about the transactions on the CER.

A DNI can be any digital asset subject to control by a CER. A DNI can include a type of financial or payment obligation that specifies, for example, an amount of the financial or payment obligation (e.g., an amount in fiat currency) and an obliging financial entity (e.g., a bank). The payment obligation can be a financial obligation of a first entity (e.g., a payor) to a second entity (e.g., a payee). In some embodiments, the first entity is a payor, a public or private person, a public or private business entity, a public or private financial entity, a government-sponsored entity, any entity in financial obligation to the second entity, or any payment system configured to process the DNI. In some embodiments, the second entity is a payee, a public or private person, a public or private business entity, a public or private financial entity, a government-sponsored entity, or any entity having an interest in the financial obligation of the first entity. In some embodiments, the first entity or the second entity is associated with a financial entity comprising an insurance company, a mortgage company, a bank, an investment bank, a commercial bank, a central bank, a credit union, a lender, a savings and loan association, a brokerage firm, a cryptocurrency exchange, or any entity having authorization to act as a monetary custodian (MC).

In some cases, the first entity may request creation of the DNI to negotiate, settle, or process the financial obligation to the second entity. Creation of the DNI may be associated with creation of at least one CER in the CER ledger through one or more ledger entries. The financial entity (e.g., monetary custodian or bank) may negotiate, settle, or process the DNI according to one or more ledger entries recording or storing transactions associated with control or ownership of the CER. For example, the financial entity may be authorized to transfer the DNI to the second entity through associated transactions on the CER ledger. The associated transactions may relate to transfer of control or ownership of the CER to the second entity. Control or ownership of the CER may establish a right of the second entity to receive the DNI in negotiation, settlement, or processing of the financial obligation of the first entity to the second entity. The financial entity may be authorized to release or otherwise transfer the DNI to the second entity when the second entity controls or owns the CER.

In some embodiments, the transfer of control or ownership comprises (i) transferring substantially all or all of the benefits of the CER to the second entity, (ii) preventing entities other than the second entity from enjoying substantially all or all of the benefits of the CER, or (iii) transferring substantially all or all of the benefits of the CER to another entity other than the second entity. For example, control or ownership of the CER, in negotiation or settlement of the financial obligation using a DNI, can be established through transacting on the CER ledger, a type of record keeping system (RKS). In some cases, the CER ledger may be structured in a database technology, a distributed ledger technology, or a blockchain technology. In some cases, as a nonlimiting example, rules for establishing control or ownership of a CER may be prescribed by the Uniform Commercial Code (UCC) Article 12. In some cases, UCC Article 12 may prescribe additional or different rules for establishing control or ownership of a CER, in which case, methods and systems described herein may implement the additional or different rules for establishing control or ownership of a CER. In some cases, UCC Article 12 may establish additional or different definitions of a CER or a DNI, in which case, methods and systems described herein may implement the additional or different definitions of a CER or a DNI.

Control or ownership can mean that the controller or the owner of the CER enjoys substantially all or all of the benefits of the CER. The first entity may initially enjoy substantially all or all of the benefits of the CER. The first entity may transact on the CER to transfer substantially all or all of the benefits of the CER to the second entity. The second entity can then enjoy substantially all or all of the benefits of the CER. Control or ownership of the CER can be transacted though one or more ledger entries in the structure of the CER ledger. A CER ledger can hold at least one CER with the DNI embedded or otherwise stored in the structure of the CER. Negotiation, settlement, or processing of the DNI can satisfy the financial obligation of the first entity to the second entity.

Additional descriptions of DNIs and CERs can be found in U.S. Patent Application No. 63/472,501 filed on Jun. 12, 2023, the entire contents of which are herein incorporated by reference in their entirety.

### Digital Drafts

In some embodiments, a digital draft may include a digital version of a traditional paper check. A digital draft may include a form of electronic funds transfer (EFT) used to make payments or transfer money from one bank account to another, typically through the Automated Clearing House (ACH) network (or other rails). Digital drafts offer several advantages over traditional paper checks, including faster processing times, lower processing fees, and reduced risk of fraud or human error. They are widely used for various types of transactions, such as bill payments, payroll, and direct deposit, as well as for individual transactions between parties.

The process for issuing and processing a digital draft may involve the following steps. First, the payor may authorize the digital draft, either by signing a written form, accepting an online agreement, or providing verbal consent. Second, the payee may provide their bank account and routing numbers, as well as the payment amount and any additional details required for the transaction. Third, the payment information may be entered into the ACH network (or some other rail or payout method), which processes the transaction and transfers the funds from the payor's bank account to the payee's bank account. Fourth, both parties may receive a confirmation of the transaction, either through email, a website, or a notification from their respective banks.

In some embodiments, digital drafts may be issued and executed using distributed ledger technology. The interface system can connect traditional finance based on fiat currency and newer financial technology based on distributed ledgers (e.g., blockchain). The interface system can integrate with banks' core systems and can execute transactions that are much faster, cheaper, and more secure. The interface system can connect with a variety of distributed ledger technologies to execute transactions on those blockchains. The interface system can orchestrate transactions between bank cores and distributed ledgers and to ensure transaction atomicity such that the full transaction is guaranteed to complete. Furthermore, transactions performed with the interface system can occur on both bank side and blockchain side and/or can be reverted back into their original state if needed. A plurality of modules can be populated such that the interface system is able to integrate with any bank core on the fiat currency interface and any distributed ledger ecosystem on the distributed ledger interface.

### Computer Systems

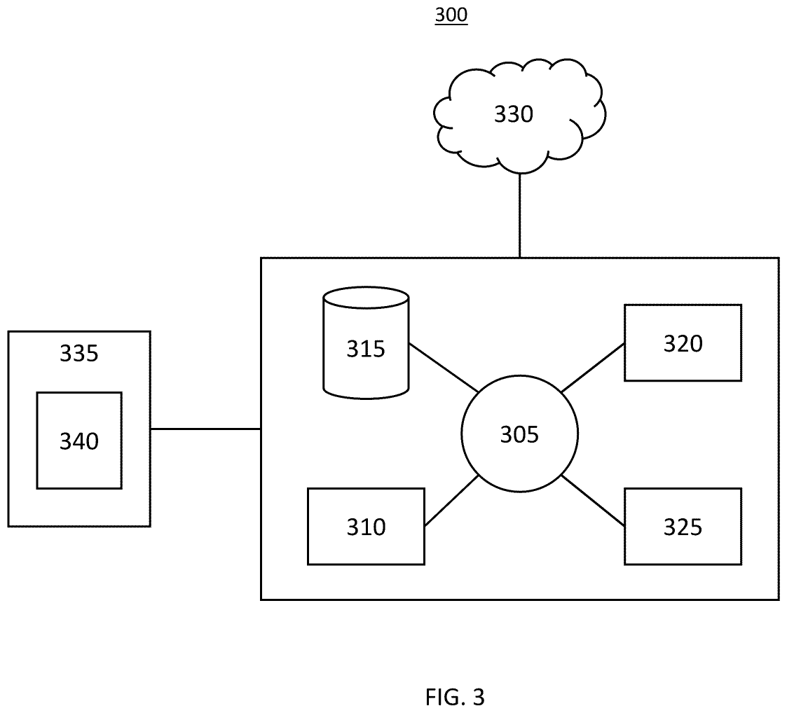

The present disclosure provides computer systems that are programmed to implement methods of the disclosure. FIG. 3 shows a computer system that is programmed or otherwise configured to verify the authenticity of the payment instrument. The computer system 300 can regulate various aspects of the present disclosure, for example, for generating the payment instrument verification system data and verifying the authenticity of the payment instrument based on the data. The computer system 300 can be an electronic device of a user or a computer system that is remotely located with respect to the electronic device.

The computer system 300 includes a central processing unit (CPU, also “processor” and “computer processor” herein) 305, which can be a single core or multi core processor, or a plurality of processors for parallel processing. The computer system 300 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage and/or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 300 can be operatively coupled to a computer network (“network”) 330 with the aid of the communication interface 320. The network 330 can be the Internet, an internet and/or extranet, or an intranet and/or extranet that is in communication with the Internet. The network 330 in some cases is a telecommunication and/or data network. The network 330 can include one or more computer servers, which can enable distributed computing, such as cloud computing. The network 330, in some cases with the aid of the computer system 300, can implement a peer-to-peer network, which may enable devices coupled to the computer system 300 to behave as a client or a server.

The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback.

The CPU 305 can be part of a circuit, such as an integrated circuit. One or more other components of the system 300 can be included in the circuit. In some cases, the circuit is an application specific integrated circuit (ASIC).

The storage unit 315 can store files, such as drivers, libraries and saved programs. The storage unit 315 can store user data, e.g., user preferences and user programs. The computer system 300 in some cases can include one or more additional data storage units that are external to the computer system 300, such as located on a remote server that is in communication with the computer system 300 through an intranet or the Internet.

The computer system 300 can communicate with one or more remote computer systems through the network 330. For instance, the computer system 300 can communicate with a remote computer system of a user (e.g., a mobile device). Examples of remote computer systems include personal computers (e.g., portable PC), slate or tablet PC's (e.g., Apple® iPad, Samsung® Galaxy Tab), telephones, smart phones (e.g., Apple® iphone, Android-enabled device, Blackberry®), or personal digital assistants. The user can access the computer system 300 via the network 330.

Methods as described herein can be implemented by way of machine (e.g., computer processor) executable code stored on an electronic storage location of the computer system 300, such as, for example, on the memory 310 or electronic storage unit 315. The machine executable or machine readable code can be provided in the form of software. During use, the code can be executed by the processor 305. In some embodiments, the code can be retrieved from the storage unit 315 and stored on the memory 310 for ready access by the processor 305. In some embodiments, the electronic storage unit 315 can be precluded, and machine-executable instructions are stored on memory 310.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 300, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 300 can include or be in communication with an electronic display 335 that comprises a user interface (UI) 340 for providing, for example, a dashboard. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft.NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft SQL Server, mySQL, and Oracle. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash ActionScript, JavaScript, or Silverlight. In some embodiments, a web application is written to some extent in a server-side coding language such as Active Server Pages (ASP), ColdFusion, Perl, Java, JavaServer Pages (JSP), Hypertext Preprocessor (PHP), Python, Ruby, Tcl, Smalltalk, WebDNA, or Groovy. In some embodiments, a web application is written to some extent in a database query language such as Structured Query Language (SQL). In some embodiments, a web application integrates enterprise server products such as IBM Lotus Domino. In some embodiments, a web application includes a media player element. In various further embodiments, a media player element utilizes one or more of many suitable multimedia technologies including, by way of non-limiting examples, Adobe Flash, HTML 5, Apple QuickTime, Microsoft Silverlight, Java, and Unity.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java, JavaScript, Pascal, Object Pascal, Python, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java, Lisp, Python, Visual Basic, and VB.NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, by way of examples, image, cell state, protocol, and culture condition information. In various embodiments, suitable databases include, by way of non-limiting examples, relational databases, non-relational databases, object-oriented databases, object databases, entity-relationship model databases, associative databases, XML databases, document-oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based at least in part on one or more local computer storage devices.

### Distributed Ledger Technology

The systems and methods disclosed herein may implement a distributed ledger technology. Generally, a distributed ledger technology may comprise geographically distributed shared and synchronized digital data. A distributed ledger technology may not have a central administrator. In some cases, a distributed ledger may be implemented across nodes implementing a consensus algorithm to determine a correctness of a ledger.

In some cases, a distributed ledger technology herein may comprise a blockchain. A blockchain is a technique that may be used for achieving a distributed consensus on validity or invalidity of information in a chain. In other words, the blockchain provides a decentralized trust to participants and observers. As opposed to using a central authority, a blockchain is a distributed database, or ledger, in which a transactional record may be maintained at each node of a peer to peer network.

The distributed ledger may be comprised of groupings of transactions bundled together into a “block,” and ordered sequentially (thus the term “blockchain”). Nodes may join and leave the blockchain network over time and may obtain blocks that were propagated while the node was gone from peer nodes. Nodes may maintain addresses of other nodes and exchange addresses of known nodes with one another to facilitate the propagation of new information across the network in a decentralized, peer-to-peer manner.

The nodes that share the ledger form what may be referred to as a distributed ledger network. The nodes in the distributed ledger network may validate changes to the blockchain (e.g., when a new transaction or block is created) according to a set of consensus rules, where each node forms a consensus as to how the change is integrated into the distributed ledger. The consensus rules may depend on the information being tracked by the blockchain and may include rules regarding the chain itself. For example, a consensus rule may include that the originator of a change supply a proof-of-identity such that only approved entities may originate changes to the chain. A consensus rule may include that blocks and transactions adhere to format requirement and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Upon consensus, the agreed upon change is pushed out to each node so that each node maintains a copy (e.g., identical copy) of the updated distributed ledger. For example, additions to the blockchain that satisfy the consensus rules may be propagated from nodes that have validated the addition to other nodes that the validating node is aware of. If all the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule may be disregarded by validating nodes that receive the change and may not be propagated to other nodes. Accordingly, unlike a central authority, a single party cannot unilaterally alter the distributed ledger, unless the single party can do so in a way that satisfies the consensus rules. This inability to modify past transactions leads to blockchains being generally described as trusted, secure, and immutable.

The validation activities of nodes applying consensus rules on a blockchain network may take various forms. For example, the blockchain may be viewed as a shared spreadsheet that tracks data such as the ownership of assets. In another example, the validating nodes execute code contained in “smart contracts” and distributed consensus is expressed as the network nodes agreeing on the output of the executed code.

A smart contract may be a computer protocol that facilitates the automatic execution or enforcement of an agreement between different parties. In particular, the smart contract may be computer code that is located at a particular address on the blockchain. In some cases, the smart contract may run automatically in response to a participant in the blockchain sending funds (e.g., digital draft) to an address where the smart contract is stored. Additionally, smart contracts may maintain a balance of the amount of funds that are stored at their address. In some cases, when this balance reaches zero the smart contract may no longer be operational. The smart contract may include one or more trigger conditions, that, when satisfied, correspond to one or more actions. For some smart contracts, which actions from the one or more actions are performed may be determined based at least in part on one or more decision conditions. In some cases, data streams may be routed to the smart contract so that the smart contract may detect that a trigger condition has occurred or analyze a decision condition.

Blockchains may be deployed as private (e.g., permissioned ledgers) blockchains that keep chain data private among a group of entities authorized to participate in the blockchain network. Other blockchain implementations may be both permissioned and permissionless whereby participants may need to be validated, but only the information that participants in the network wish to be public is made public.

In some cases, to create a new block in a blockchain, each transaction within a block may be assigned a hash value (e.g., an output of a cryptographic hash function, such as SHA-256 or MD5). These hash values may then be combined together utilizing data storage and cryptographic techniques (e.g., a Merkle Tree) to generate a hash value representative of the entire new block, and consequently the transactions stored in the block. This hash value may then be combined with the hash value of the previous block to form a hash value included in the header of the new block, thereby cryptographically linking the new block to the blockchain. To this end, the precise value utilized in the header of the new block may be dependent on the hash value for each transaction in the new block, as well as the hash value for each transaction in every prior block.

In some cases, information stored in blockchains may be trusted (e.g., at least partially trusted), because the hash value generated for the new block and a nonce value (an arbitrary number used once) may be used as inputs into a cryptographic puzzle. The cryptographic puzzle may have a difficulty set by the nodes connected to the blockchain network, or the difficulty may be set by administrators of the blockchain network. In one example of the cryptographic puzzle, a solving node uses the hash value generated for the new block and repeatedly changes the value of the nonce until a solution for the puzzle is found. For example, finding the solution to the cryptographic puzzle may involve finding the nonce value that meets certain criteria (e.g., the nonce value begins with five zeros).

When a solution to the cryptographic puzzle is found, the solving node publishes the solution and the other nodes may then verify that the solution is valid. Since the solution may depend on the particular hash values for each transaction within the blockchain, if the solving node attempts to modify any transaction stored in the blockchain, the solution may not be verified by the other nodes. More specifically, if a single node attempts to modify a prior transaction within the blockchain, a cascade of different hash values may be generated for each tier of the cryptographic combination technique. This may result in the header for one or more blocks being different than a corresponding header in every other node that did not make the exact same modification.

While preferred embodiments of the present disclosure have been shown and described herein, it will be obvious to those skilled in the art that such embodiments are provided by way of example only. It is not intended that the present disclosure be limited by the specific examples provided within the specification. While the embodiments of the present disclosure have been described with reference to the aforementioned specification, the descriptions and illustrations of the embodiments herein are not meant to be construed in a limiting sense. Numerous variations, changes, and substitutions will now occur to those skilled in the art without departing from the embodiments of the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the embodiments of the present disclosure. It is therefore contemplated that the present disclosure shall also cover any such alternatives, modifications, variations or equivalents. It is intended that the following claims define the scope of the invention(s) and that methods and structures within the scope of these claims and their equivalents be covered thereby.

What is claimed is:

1. A method for validating financial network traffic to authenticate payment instruments, comprising:
(a) generating, at least in part by a verification engine comprising a hash function, payment instrument verification system (PIVS) data, wherein the hash function outputs a unique string of characters for a payment instrument associated with a payor;
(b) detecting, from payment instrument data received from a payee, a subset of information associated with a payment instrument associated with the payee;
(c) processing the data received from the payee using at least a PIVS database comprising the PIVS data to determine authenticity of the payment instrument associated with the payee; and
(d) blocking a transfer of funds from the payor to the payee upon determining a lack of authenticity of the payment instrument associated with the payee.

2. The method of claim 1, further comprising generating the PIVS data based at least in part on the unique string of characters and a payor's private key.

3. The method of claim 1, further comprising comparing a portion of the PIVS data that was generated by the hash function to the subset of information received from the payee.

4. The method of claim 3, wherein the subset of information comprises the PIVS data, payor name, payor address, payment amount, date, routing number, account number, check number, or electronic signature.

5. The method of claim 1, wherein the payment instrument comprises a check, and wherein payment instrument data comprises one or more of payor's information, payee's information, date, amount, account information, check number, or a check memorandum section.

6. The method of claim 5, further comprising, prior to (a), generating an image of the check based at least in part on the payment instrument associated with the payor.

7. The method of claim 6, wherein the image comprises a scanned copy of a physical check comprising the check, wherein the physical check is handwritten or printed.

8. The method of claim 7, further comprising, after generating the image, electronically augmenting or superimposing the PIVS data over the image of the check.

9. The method of claim 6, wherein the image comprises a digitally generated image without a physical check or a scanned copy thereof.

10. The method of claim 9, wherein the digitally generated image comprises the PIVS data on the image.

11. The method of claim 10, wherein the PIVS data does not overlap the payment instrument data on the check.

12. The method of claim 6, further comprising transmitting the image of the check to the payee.

13. The method of claim 12, wherein the image comprises a QR code that reveals the PIVS data when scanned.

14. The method of claim 6, further comprising, after (d), receiving an image of the check from the payee to validate the check.

15. The method of claim 14, further comprising, after receiving the image of the check, extracting the subset of information associated with the payment instrument associated with the payee.

16. The method of claim 15, further comprising, after extracting the subset of information, providing the additional payment instrument data to the PIVS database to re-assess the authenticity of the check.

17. The method of claim 1, wherein the payment instrument comprises a digital negotiable instrument (DNI), and wherein payment instrument data comprises one or more of a version of a DNI data structure, a version of a DNI record, an identification of the payee using a public key associated with the payee, an identification of the payor using a public key associated with the payor, an amount of the DNI, a creation day or time, an update day or time, a digital signature of the payor, a digital signature of the payee, a number of permissible transactions, a duration of time to negotiate or settle the DNI, a negotiable indicator, a funds guarantee indicator, an identification of a financial entity, a status of the DNI, optional data associated with processing of the DNI, or one or more types of metadata associated with the financial obligation.

18. The method of claim 1, wherein the payment instrument comprises a digital draft, and wherein payment instrument data comprises one or more of a version of a digital draft data structure, a version of a digital draft record, an identification of the payee using a public key associated with the payee, an identification of the payor using a public key associated with the payor, an amount of the digital draft, a creation day or time, a digital signature of the payor, a digital signature of the payee, a number of permissible transactions, a duration of time to negotiate or settle the digital draft, a negotiable indicator, a funds guarantee indicator, an identification of a financial entity, a status of the digital draft, optional data associated with processing of the digital draft, or one or more types of metadata associated with the financial obligation.

19. The method of claim 1, wherein the PIVS database comprises a table or array that links the PIVS data to the payment instrument associated with the payor.

20. The method of claim 1, further comprising, transmitting to one or both of a payor device or a payee device a notification of a failed transaction, and displaying the notification in real-time.
